(19) United States
(12) Patent Application Publication
(10) Pub. No.: US 2025/0284254 A1
(43) Pub. Date: Sep. 11, 2025

(54) LEARNING CONTROL DEVICE, LEARNING CONTROL METHOD, AND MAGNETIC DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yoshiyuki ISHIHARA, Kawasaki Kanagawa (JP); Shinji TAKAKURA, Yokohama Kanagawa (JP); Makihiko ISHITANI, Yokohama Kanagawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/049,286

(22) Filed: Feb. 10, 2025

(30) Foreign Application Priority Data
Mar. 5, 2024 (JP) 2024-032652

(51) Int. Cl. G05B 13/02; G05B 19/16

(52) U.S. Cl. CPC G05B 13/0265; G05B 19/16

(57) ABSTRACT

A learning-control device includes a feedback-control unit 30 and a learning-control unit 40. The feedback-control unit 30 outputs, based on an input signal according to a tracking error between an operation-result-state of a control target operating according to an input-control-signal based on a feedback-signal and a target-state, the feedback-signal causing the operation-result-state of the control target 34 to track the target-state. The learning-control unit 40 outputs to the feedback-path F, through which the input signal according to the tracking error is input to the feedback-control unit 30, the learning-control input updated according to the tracking error causing the tracking error to approach zero asymptotically. The evaluation section length of an evaluation section by the learning-control unit 40 for the tracking error is longer than the output section length of the output section in which the learning-control unit 40 outputs the learning-control inputs to the feedback-path F.

### CROSS-REFERENCE TO RELATED APPLICATIONS

This application is based upon and claims the benefit of priority from Japanese Patent Application No. 2024-032652, filed on Mar. 5, 2024; the entire contents of which are incorporated herein by reference.

### FIELD

Embodiments of the present disclosure described herein relate to a learning control device, a learning control method, and a magnetic disk device.

### BACKGROUND

As a digital control device, a learning control device is known that iteratively controls a control target according to learning control inputs stored in a learning memory and uses a tracking error between a target value and an output value of the control target to sequentially update the learning control inputs to be used for a next iterative learning to improve a control performance.

However, by conventional technologies, although the tracking error is suppressed and an accuracy of an operation result state of the control target is improved while the learning control inputs updated by learning control and the target value are applied to a feedback path, a transient response occurs at the moment when the learning control is terminated, and the accuracy of the operation result state of the control target relative to a target state may deteriorate.

### BRIEF DESCRIPTION OF THE DRAWINGS

FIG. 1 is a block diagram of a configuration of a main part of a hard disk drive (HDD);

FIG. 2 is a block diagram of an example configuration of a seek control section;

FIG. 3 is an explanatory diagram of conventional learning control;

FIG. 4 is a schematic diagram of the seek control section;

FIG. 5 is an explanatory diagram of the conventional learning control;

FIG. 6 is an explanatory diagram of the conventional learning control;

FIG. 7 is a schematic diagram of a relationship between an evaluation section length and an output section length in the conventional technology;

FIG. 8 is a schematic diagram of a relationship between an evaluation section length and an output section length according to the present embodiment;

FIG. 9 is an explanatory diagram of a learning control;

FIG. 10 is a diagram illustrating an impulse response;

FIG. 11 is an explanatory diagram of a finite impulse response (FIR) filter;

FIG. 12 is a schematic diagram of a learning control unit;

FIG. 13 is an explanatory diagram of a result of a numerical simulation;

FIG. 14 is an explanatory diagram of a result of a numerical simulation;

FIG. 15 is an explanatory diagram of a result of a numerical simulation;

FIG. 16 is an explanatory diagram of a result of a numerical simulation;

FIG. 17 is an explanatory diagram of a result of a numerical simulation;

FIG. 18 is an explanatory diagram of results of numerical simulations; and

FIG. 19 is an explanatory diagram of results of numerical simulations.

### DETAILED DESCRIPTION

According to an embodiment, a learning control device includes one or more hardware processors configured to function as a feedback control unit and a learning control unit. The feedback control unit outputs, based on an input signal according to a tracking error between an operation result state of a control target operating according to an input control signal based on a feedback signal and a target state, the feedback signal to cause the operation result state of the control target to track the target state. The learning control unit outputs to a feedback path, through which the input signal according to the tracking error is sent to be input to the feedback control unit, a learning control input updated according to the tracking error to cause the tracking error to approach zero asymptotically. The evaluation section length of an evaluation section by the learning control unit for the tracking error is longer than an output section length of an output section in which the learning control unit outputs the learning control input to the feedback path.

Embodiments of a learning control device, a learning control method, and a magnetic disk device according to the present disclosure will be described in detail below with reference to accompanying drawings. The present disclosure is not limited to the following embodiments.

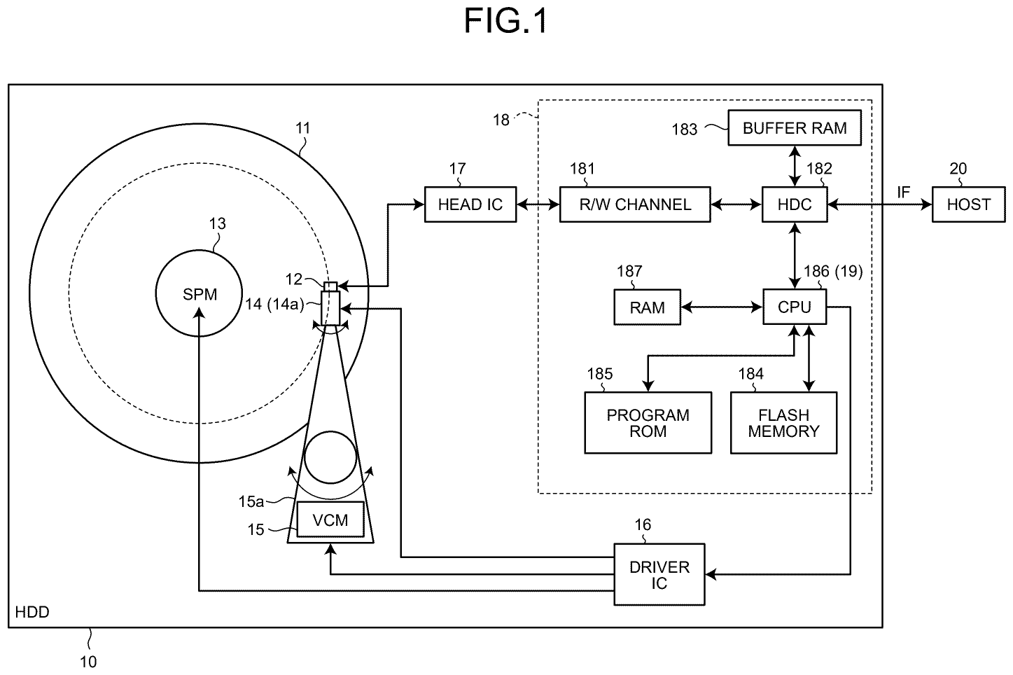

FIG. 1 is a block diagram illustrating an example of a configuration of a main part of a hard disk drive (HDD) 10 according to the present embodiment. The HDD 10 is an example of the magnetic disk device and the learning control device.

A Host 20 is a device that uses the HDD 10 as a storage device. The Host 20 is connected to the HDD 10 by a host interface IF.

The HDD 10 includes one or more magnetic disks 11, magnetic heads 12, a spindle motor (SPM) 13, micro actuators (MAs) 14, support members 14a, a voice coil motor (VCM) 15, an arm 15a, a driver integrated circuit (driver IC) 16, a head IC 17, and a system large scale integration (system LSI) 18.

The magnetic disks 11 are magnetic recording media and are stacked and arranged at regular intervals. The magnetic disk 11 has an upper disk surface and a lower disk surface. In the present embodiment, both surfaces (upper disk surface and lower disk surface) of the magnetic disk 11 are recording surfaces on which data is magnetically recorded. The magnetic disk 11 is rotated at high speed by the SPM 13. The HDD 10 may include one magnetic disk 11 or a plurality of (for example, 10 or more of) the magnetic disks 11.

The magnetic heads 12 are disposed so as to correspond to the recording surfaces in both surfaces (upper disk surface and lower disk surface) of each magnetic disk 11 and are used to write data to the recording surface of the magnetic disk 11 and to read the data written in the recording surface. The magnetic head 12 is mounted on the tip of the support member 14a.

The SPM 13 is driven by a driving current (or driving voltage) supplied by the driver IC 16.

The support member 14a supports the magnetic head 12 and is provided at the tip of the arm 15a. The support member 14a is, for example, a slider or a suspension.

The MA 14 is attached to the base or tip of the support member 14a and drives the support member 14a. The MA 14 is a piezoelectric device such as a piezoelectric element. The MA 14 corresponds to an actuator that drives the tip side of a two-stage actuator. The MA 14 can be driven faster and more accurately than the VCM 15. Therefore, the seek control can be sped up by operating the MA 14 prior to the VCM 15.

The VCM 15 rotates the arm 15a. The VCM 15 corresponds to an actuator that moves the head relatively largely. In contrast, the MA 14 corresponds to an actuator that moves the support member 14a provided at the tip of the arm 15a slightly (in a relatively small manner).

The VCM 15 and the MA 14 are driven by an input control signal supplied by the driver IC 16. This causes the magnetic head 12 to move toward the radial direction of the magnetic disk 11. The input control signal is, for example, a driving current or a driving voltage. In other words, the magnetic head 12 is an example of a control target. The VCM 15 and the MA 14 are also examples of the control targets.

The driver IC 16 drives the SPM 13, the MA 14, and the VCM 15 according to control by a central processing unit (CPU) 186 to be described below in the system LSI 18.

The head IC 17 amplifies a signal (read signal) read by the magnetic head 12. The head IC 17 converts a write data transferred from a read/write (R/W) channel 181 to be described below in the system LSI 18 into a write current to be output to the magnetic head 12.

The system LSI 18 is an LSI called a system on a chip (SoC) in which a plurality of elements are integrated on one chip. The system LSI 18 includes the R/W channel 181, a hard disk controller (HDC) 182, a buffer random access memory (RAM) 183, a flash memory 184, a program read only memory (ROM) 185, the CPU 186, and a RAM 187.

The R/W channel 181 is a signal processing device that processes a group of signals related to reading and writing. The R/W channel 181 digitizes the read signal and decodes the read data from the digitized data. The R/W channel 181 also acquires, from the digitized data, a servo data necessary for positioning the magnetic head 12. Furthermore, the R/W channel 181 encodes the write data.

The HDC 182 is connected to the host 20 via the host interface IF. The HDC 182 receives commands (write commands, read commands, etc.) transferred from the host 20. The HDC 182 controls data transfer between the host 20 and the HDC 182. The HDC 182 also controls data transfer between the magnetic disk 11 and the HDC 182.

The buffer RAM 183 constitutes a buffer area for temporarily storing data to be written to and read from the magnetic disk 11 via the head IC 17 and the R/W channel 181.

The flash memory 184 is a rewritable nonvolatile memory.

The program ROM 185 stores a control program (firmware). The control program may be stored in some areas of the flash memory 184. The control program is a computer program used after shipment.

The CPU 186 functions as a main controller of the HDD 10. The CPU 186 controls at least some elements in the HDD 10 according to the control program or an adjustment program stored in the program ROM 185. The CPU 186 includes a seek control section 19 described below.

At least some areas of the RAM 187 is used as a working area for the CPU 186.

The HDD 10 configured as described above includes a feedback control system that performs the seek control of the magnetic head 12. The seek control refers to control the positioning of the magnetic head 12 at a target track. The feedback control system is executed, for example, by the CPU 186, at regular time intervals, that is, each time servo data is acquired. Hereafter, this regular time interval is referred to as a sampling time or a sampling period. A step of sampling data at each sampling time is referred to as a sampling step.

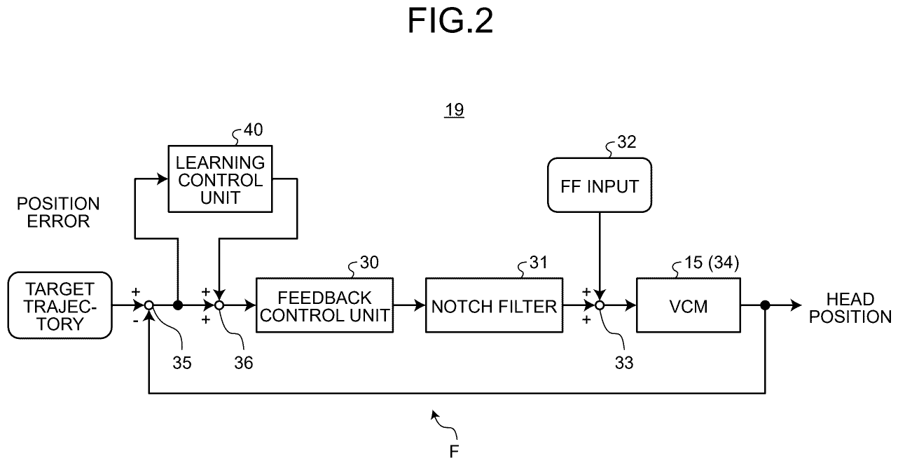

FIG. 2 is a block diagram illustrating an example configuration of a seek control section 19. The seek control section 19 executes seek control of the magnetic head 12.

In the seek control section 19, a feedback path F is used for each of the VCM 15 and the MA 14. In the present embodiment, the learning control is assumed to act on the movement of the VCM 15, and a configuration of the feedback path F with respect to the VCM 15 is described as an example.

The seek control section 19 is a digital control device that performs learning control of iteratively controlling a control target 34 and sequentially updating learning control inputs to improve control performance at each iteration.

The control target 34 has an actuator and is controlled by the seek control section 19. The control target 34 is a target of state control by the seek control section 19, and is the magnetic head 12 to be position-controlled by the VCM 15 and the MA 14 in the HDD 10, semiconductor manufacturing equipment, a robot, and the like. The control target 34 may have the position of an end effector of an arm and the angle of each joint controlled.

A state of the control target 34 is, for example, a head position of the magnetic head 12 on the magnetic disk 11, the position of the robot, and the like. The state of the control target 34 is not limited to position. For example, the state of the control target 34 may be a combination of a position and a velocity, a combination of the velocity and an acceleration, a combination of the position, the velocity, the acceleration, and external forces. The state of the control target 34 preferably includes at least one of the position and the velocity of the control target 34. The state of the control target 34 may include the external forces applied to the control target 34. The external forces applied to the control target 34 are, for example, bias forces.

In the present embodiment, an example in which the control target 34 is the magnetic heads 12 to be position-controlled by the VCM 15 and the state of the control target 34 is the head position of the magnetic head 12 will be described.

The seek control section 19 includes a learning control unit 40, a feedback control unit 30, a notch filter 31, an adder 33, the VCM 15, an error calculation unit 35, and an adder 36.

The VCM 15 operates according to the input control signal sequentially received from the feedback control unit 30 via the notch filter 31 and the adder 33, and sequentially outputs an operation result state representing a state of an operation result. The input control signal is, for example, the driving current or the driving voltage, as described above.

In the present embodiment, the magnetic head 12 sequentially outputs, as the operation result state, the position of the magnetic head 12 position-controlled by the VCM 15 on the magnetic disk 11. The operation result state may be configured to be detected by a detection device such as a known sensor or based on servo data acquired via the magnetic head 12.

The error calculation unit 35 calculates a tracking error. The tracking error represents an error of the operation result state of the control target 34 relative to a target state. In other words, the tracking error represents an error of a current state of the control target 34 relative to the target state. In the present embodiment, the error calculation unit 35 calculates a position error between the head position of the magnetic head 12 and a target trajectory as the tracking error. The target trajectory is a target position of the magnetic head 12 and is an example of the target state.

The error calculation unit 35 outputs the calculated position error to the learning control unit 40 and the feedback control unit 30. In other words, the error calculation unit 35 sequentially receives the head position which is the operation result state output at each sampling period, calculates a position error which is the tracking error relative to the target trajectory each time the head position is received, and outputs the position error to the learning control unit 40 and the feedback control unit 30.

The adder 36 adds the position error received from the error calculation unit 35 to the learning control input received from the learning control unit 40, and outputs the result to the feedback control unit 30.

The learning control input is a learning value that is learned through iterative learning by the learning control unit 40. The learning control input is used to correct a signal output to the control target 34 such as the VCM 15. In other words, the learning control input represents a correction amount used during learning control.

The feedback control unit 30 outputs a feedback signal to cause the operation result state of the control target 34 to track the target state, based on an input signal according to the tracking error between the operation result state of the control target 34 and the target state. In the present embodiment, the feedback control unit 30 outputs the feedback signal to cause the head position of the magnetic head 12, the head position being moved according to the input control signal, to track the target trajectory, based on the position error of the head position relative to the target trajectory on the magnetic disk 11.

The notch filter 31 is a filter used to stabilize mechanical resonance of the VCM 15. The notch filter 31 removes mechanical resonance frequency components of the VCM 15 from the feedback signal received from the feedback control unit 30 using the filter, and outputs a resultant signal to the adder 33.

The adder 33 outputs the calculation result of adding the output signal of the notch filter 31 and the inputted feed-forward (FF) input 32 to the VCM 15 as the above input control signal. The FF input 32 represents an input for feed-forward control of the VCM 15. The FF input 32 is expressed, for example, in the dimension of acceleration.

Thus, the seek control section 19 is provided with the feedback path F. The feedback path F is a communication path through which the input control signal, according to the feedback signal output by the feedback control unit 30, is input to the VCM 15 (control target 34) and also the tracking error (position error) based on the operation result state (head position) of the control target 34 (magnetic head 12) according to the input control signal is input to the feedback control unit 30. The feedback path F operates such that the position error between the head position of the magnetic head 12, which is output by the VCM 15, and the target trajectory of the seek control approaches zero asymptotically.

The learning control unit 40 outputs to the feedback path F, through which the input signal according to the tracking error is sent to be input to the feedback control unit 30, the learning control input that has been updated according to the tracking error to cause the tracking error to approach zero asymptotically. Since the seek control section 19 includes the learning control unit 40, seek settling can be improved.

In the present embodiment, the learning control unit 40 outputs to the feedback path F, through which an input signal according to the position error is sent to be input to the feedback control unit 30, the learning control input updated according to the position error to cause the position error to approach zero asymptotically. Furthermore, in the present embodiment, an example in which the learning control unit 40 outputs the learning control input to an input end of the feedback control unit 30 in the feedback path F will be described. Therefore, in the present embodiment, the adder 36 outputs an addition result obtained by adding the position error to the learning control input to the feedback control unit 30 as an input signal.

The learning control unit 40 may output the learning control input to the input end of the VCM 15, which is the control target 34 in the feedback path F. In this case, the adder 36 is arranged on the input end of the VCM, and an addition result obtained by adding the learning control signal to a calculation result obtained by adding the output signal of the notch filter 31 to the FF input 32 using the adder 33 may be output to the VCM 15 as the input control signal. As described above, the control target 34 of the seek control section 19 may be semiconductor manufacturing equipment, a robot, and the like. For example, if the control target 34 is a robot, the feedback path F may be applied to the position of an end effector of the robot or to the angle of each joint instead of the head position of the magnetic head 12.

Hereinafter, a conventional learning control will be described.

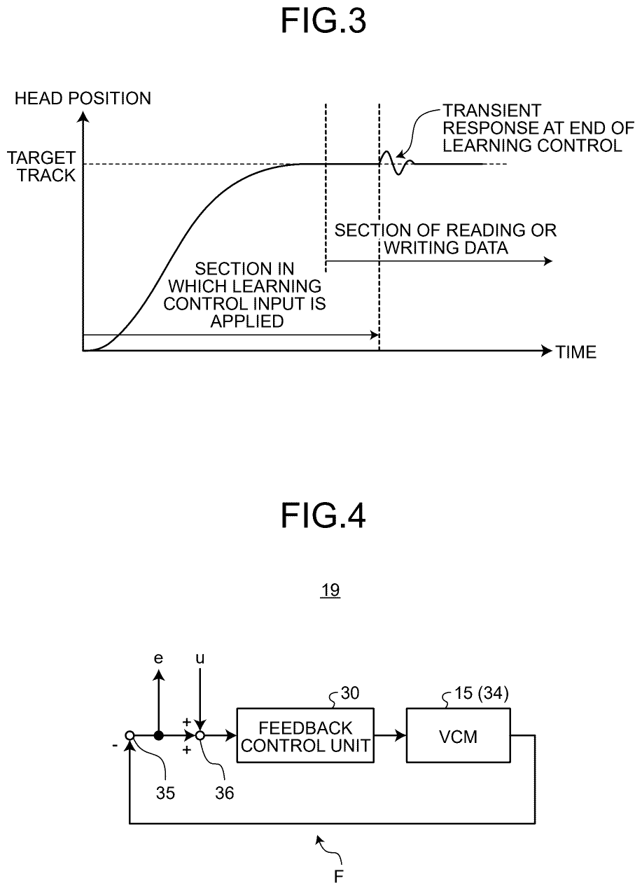

FIG. 3 is an explanatory diagram of an example of conventional learning control. As illustrated in FIG. 3, in the conventional learning control, a head positioning accuracy of the magnetic head 12 is improved in a section (period) where the learning control inputs generated by the learning control and the target trajectory are applied to the feedback path F. However, in the conventional learning control, a transient response may occur at the moment when the learning control is terminated, and head positioning accuracy may deteriorate. In other words, in the conventional technologies, the accuracy of the operation result state of the control target 34 relative to the target state may decrease.

First, the reason why the transient response occurs at the end of learning control will be described in detail.

FIG. 4 is a schematic diagram of an example of the seek control section 19.

To analyze an operation of the learning control, it is assumed that each element of the seek control section 19 described using FIG. 2 is a linear system, and a time response of the position error during the seek control when the learning control is active will be considered. This consideration uses a sequence of impulse responses p₁, p₂, . . . , pₙ₋₁, pₙ of the transfer characteristics of a closed loop from e to u, which connects the learning control unit 40 in the feedback path F as illustrated in FIG. 4. e represents the tracking error. In other words, in the present embodiment, e represents the position error. u represents the learning control input. The sequence of impulse responses is a group of position errors e at each sampling time output from the control target 34 over time when one learning control input u is output from the learning control unit 40 to the feedback path F. n is an integer of 2 or more. Numerical subscripts of P represent the sampling times i=0, 1, 2, . . . , n.

Let e be a vector in which the above position errors are arranged at each sampling time, P be a matrix in which the above sequences of impulse responses p₁, p₂, . . . , pₙ₋₁, pₙ are arranged in lower triangle portion in expression (2) described below while being shifted by one sampling time, u be a vector in which each of the learning control inputs generated by the learning control using the learning control unit 40 is arranged at each corresponding sampling time, and d be a vector of position errors in the seek control when the learning control is disabled, then the following expression (1) is established.

$$e = Pu + d \qquad expression ( 1 )$$

In expression (1), e represents the vector of position errors, P represents the matrix in which sequences of impulse responses p₁, p₂, . . . , pₙ₋₁, pₙ are arranged while being shifted by one sampling time, u represents the vector of learning control inputs, and d represents the vector of position errors when the learning control is disabled. In the following description, the vector of position errors may be referred to as a position error vector and the vector of learning control inputs as a learning control input vector.

For example, when an output section length of an output section of the learning control input output from the learning control unit 40 to the feedback path F is “7” and components of the above expression (1) are expressed at each sampling time i=0, 1, 2, . . . , n, expression (2) is obtained.

$$[ \begin{matrix}{e}_{1} \\ {e}_{2} \\ {e}_{3} \\ {e}_{4} \\ {e}_{5} \\ {e}_{6} \\ {e}_{7} \\ {e}_{8} \\ {e}_{9} \\ {e}_{10} \\ ⋮ \\ {e}_{n}\end{matrix} ] = [ \begin{matrix}{p}_{1} & & & & & & & & & & & \\ {p}_{2} & {p}_{1} & & & & & & & & & & \\ {p}_{3} & {p}_{2} & {p}_{1} & & & & & & & & & \\ {p}_{4} & {p}_{3} & {p}_{2} & {p}_{1} & & & & & & & & \\ {p}_{5} & {p}_{4} & {p}_{3} & {p}_{2} & {p}_{1} & & & & & & & \\ {p}_{6} & {p}_{5} & {p}_{4} & {p}_{3} & {p}_{2} & {p}_{1} & & & & & & \\ {p}_{7} & {p}_{6} & {p}_{5} & {p}_{4} & {p}_{3} & {p}_{2} & {p}_{1} & & & & & \\ {p}_{8} & {p}_{7} & {p}_{6} & {p}_{5} & {p}_{4} & {p}_{3} & {p}_{2} & {p}_{1} & & & & \\ {p}_{9} & {p}_{8} & {p}_{7} & {p}_{6} & {p}_{5} & {p}_{4} & {p}_{3} & {p}_{2} & {p}_{1} & & & \\ {p}_{10} & {p}_{9} & {p}_{8} & {p}_{7} & {p}_{6} & {p}_{5} & {p}_{4} & {p}_{3} & {p}_{2} & {p}_{1} & & \\ ⋮ & ⋮ & ⋮ & ⋮ & ⋮ & ⋮ & ⋱ & ⋱ & ⋱ & ⋱ & ⋱ & \\ {p}_{n} & {p}_{n - 1} & {p}_{n - 2} & {p}_{n - 3} & {p}_{n - 4} & {p}_{n - 5} & ⋯ & {p}_{5} & {p}_{4} & {p}_{3} & {p}_{2} & {p}_{1}\end{matrix} ] [ \begin{matrix}{u}_{0} \\ {u}_{1} \\ {u}_{2} \\ {u}_{3} \\ {u}_{4} \\ {u}_{5} \\ {u}_{6} \\ 0 \\ 0 \\ 0 \\ ⋮ \\ 0\end{matrix} ] + [ \begin{matrix}{d}_{1} \\ {d}_{2} \\ {d}_{3} \\ {d}_{4} \\ {d}_{5} \\ {d}_{6} \\ {d}_{7} \\ {d}_{8} \\ {d}_{9} \\ {d}_{10} \\ ⋮ \\ {d}_{n}\end{matrix} ] \qquad expression ( 2 )$$

In general learning control, the learning control unit 40 stores the learning control inputs in a memory provided in the learning control unit 40 at each seek control and iteratively updates the learning control inputs based on the position error in the next seek control.

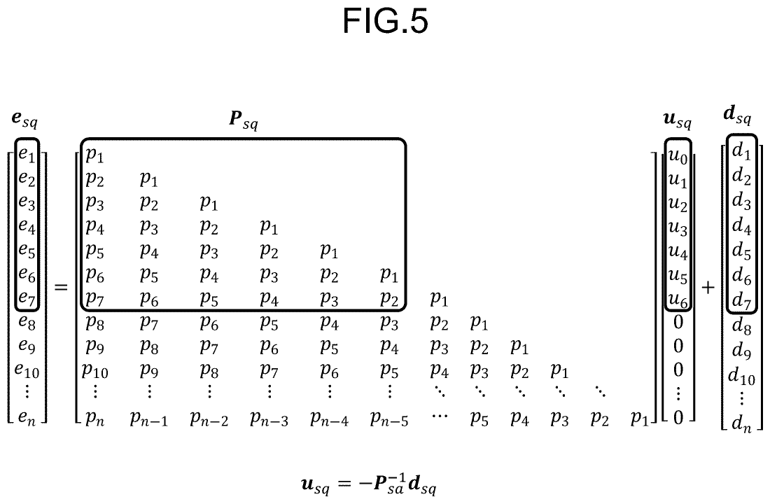

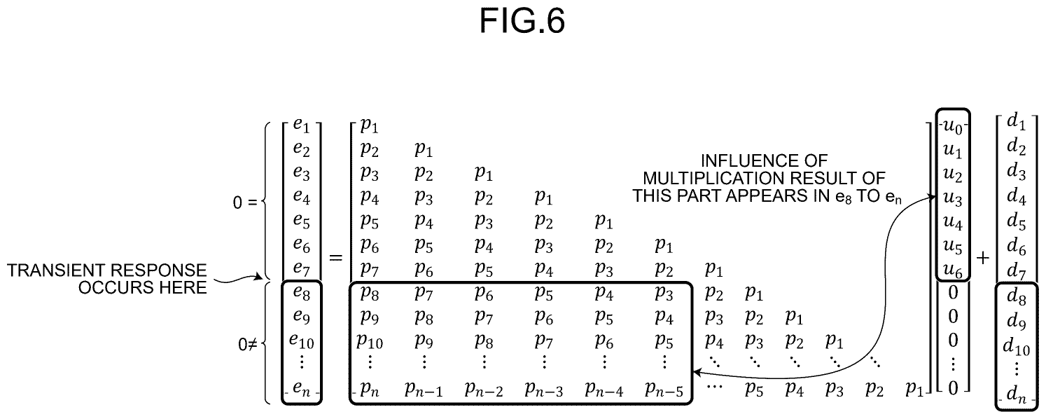

FIGS. 5 and 6 are explanatory diagrams of examples of the conventional learning control.

In the conventional technologies, when the learning control inputs stored in the memory are updated, position error signals e₁ to e₇ in an evaluation section having the same length as the length of the output section of the learning control inputs output from the learning control unit to the feedback path F are used. Therefore, when the learning converges sufficiently, learning control inputs converge to expression (3), as illustrated in FIG. 5, where P_{sq} and d_{sq} are portions at which the learning control inputs u₀ to u₆ act on the matrix P and the vector d.

$${u}_{sq} = - {P}_{sa}^{- 1} {d}_{sq} \qquad expression ( 3 )$$

As illustrated in FIG. 6, the learning control inputs u_{sq} after convergence in the conventional technology, which are determined by expression (3), are zero in the range of the position errors e₀ to e₇, and therefore, the position errors are theoretically completely suppressed. However, in practice, the position errors e₈, . . . after the position error e₇ do not necessarily become zero, and this influence appears as a transient response at the end of the learning control between the position error e₇ and the position error e₈.

Thus, in the conventional technology, a transient response may occur at the moment when the learning control is terminated, and head positioning accuracy may deteriorate. In other words, in the conventional technology, the accuracy of the operation result state of the control target 34 relative to the target state may decrease.

Therefore, the learning control unit 40 according to the present embodiment controls an evaluation section length N of the evaluation section in which the position error is evaluated, which is the tracking error, to be longer than an output section length M of the output section in which the learning control unit 40 outputs the learning control inputs to the feedback path F.

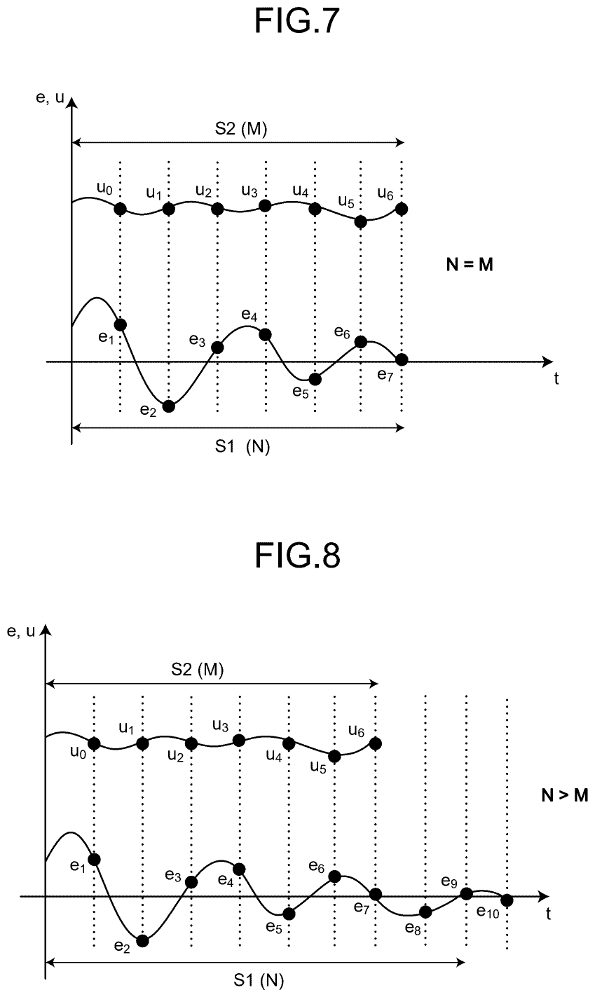

FIG. 7 is a schematic diagram illustrating an example of the relationship between the evaluation section length N of the evaluation section S1 and the output section length M of the output section S2 in the conventional technology. In FIG. 7, the black dots indicate the sampling points for each of the position errors and the learning control inputs. As illustrated in FIG. 7, in the conventional technology, the evaluation section length N matches the output section length M of the output section S2. Furthermore, in the conventional technology, the number of samplings in the evaluation section S1 matches the number of outputs in the output section S2.

FIG. 8 is a schematic diagram illustrating an example of the relationship between the evaluation section length N of the evaluation section S1 and the output section length M of the output section S2 according to the present embodiment. In FIG. 8, the black dots indicate the sampling points for each of the position errors and the learning control inputs. As illustrated in FIG. 8, in the present embodiment, the evaluation section length N of the position errors is longer than the output section length M of the learning control inputs. In the present embodiment, the number of outputs in the output section S2 is less than the number of samplings in the evaluation section S1. In the present embodiment, the timing of the last sampling e₁₀ in the evaluation section S1 is located later than the timing of the last output us in the output section S2. In the present embodiment, for example, the time interval of sampling in the evaluation section S1 matches the time interval of output in the output section S2.

As illustrated in FIG. 8, the evaluation section S1 and the output section S2 partially overlap each other. The evaluation section S1 includes a timing period later (later in time) than the output section S2. In detail, as illustrated in FIG. 8, the start timing of evaluation section S1 matches the start timing of output section S2, and the end timing of evaluation section S1 is later than the end timing of output section S2.

In other words, in the present embodiment, in order to mitigate the transient response, the learning control unit 40 performs iterative learning including the position errors e₈ to eₙ after the learning control inputs u₀ to u₆ have been applied to the feedback path F so as to satisfy the relationship of the evaluation section length N>the output section length M.

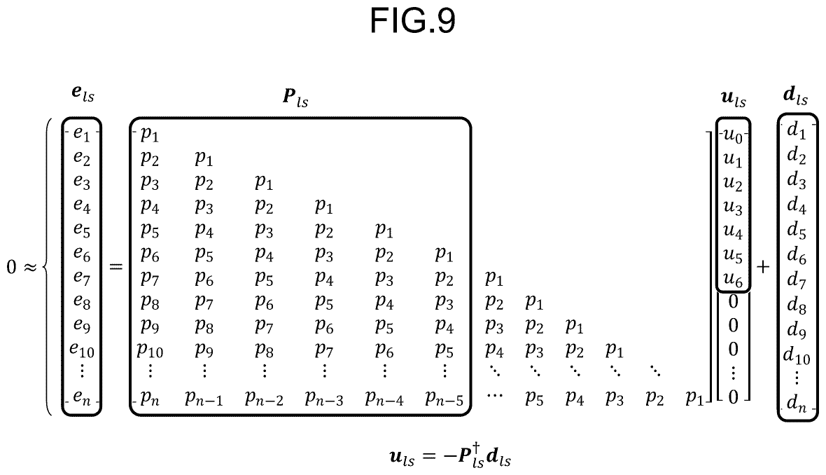

Therefore, as illustrated in FIG. 9, the learning control unit 40 extends portions at which the learning control inputs u₀ to u₆ act on the matrix P and the vector d as compared with the conventional technologies (see FIG. 5). FIG. 9 is an explanatory diagram of an example of learning control according to the present application. The learning control unit 40 performs control such that the evaluation section length N of the position errors is longer than the output section length M of the learning control inputs by performing iterative learning for obtaining the least-squares solution of the following expression (4) with the matrix P after extension and the vector d after extension defined as Pₗₛ and dₗₛ, respectively.

$${u}_{ls} = - {P}_{ls}^{\vert} {d}_{ls} \qquad expression ( 4 )$$

$$† \qquad expression ( 4 A )$$

In expression (4), uₗₛ represents the vector of learning control inputs, pₗₛ represents the matrix in which the sequences of impulse responses are arranged while being shifted by one sampling time, dis represents the vector of tracking errors when the learning control is disabled, and expression (4A) in the expression (4) represents a pseudo-inverse matrix operation.

According to the learning control inputs uₗₛ in expression (4), the position error signals e do not converge to zero completely in principle. However, unlike the conventional learning control, expression (4) also takes into account the position errors after the learning control inputs have been applied to the feedback path F. Therefore, the learning control unit 40 can perform control such that the evaluation section length N of the position errors is longer than the output section length M of the learning control inputs by performing iterative learning for obtaining the least-squares solution of expression (4), and can thereby mitigate the above transient response.

Furthermore, it is considered that the learning control unit 40 iteratively updates the learning control inputs at each seek control by performing the iterative learning according to expression (4). In this case, since expression (4) is the least-squares solution, in iterative updating the learning control inputs, uₗₛ in expression (4) is approximately obtained by performing iterative calculation using a gradient method with an objective function that minimizes a squared norm of the position error vector eₗₛ. The update expression for this iterative calculation is expressed by expression (5) below.

$${u}_{ls}^{( j + 1 )} = {u}_{ls}^{( j )} + β {P}_{is}^{T} {e}_{ls}^{( j )} \qquad expression ( 5 )$$

In expression (5), uₗₛ represents the vector of learning control inputs, pis represents the matrix in which the sequences of impulse responses are arranged while being shifted by one sampling time, and eₗₛ represents the vector of the position errors. In expression (5), j represents the number of learning iterations, and β represents the learning gain.

In other words, the learning control unit 40 can perform control such that the evaluation section length N of the position errors is longer than the output section length M of the learning control inputs by performing the iterative learning according to expression (5).

Here, the matrix Pₗₛ including the sequences of impulse responses of the closed-loop transfer characteristics in expression (5) may be difficult to acquire accurately in practice. Therefore, some approximation is needed. Consequently, the learning control unit 40 calculates the closed-loop transfer characteristic model based on a model of the VCM 15 to acquire its impulse response.

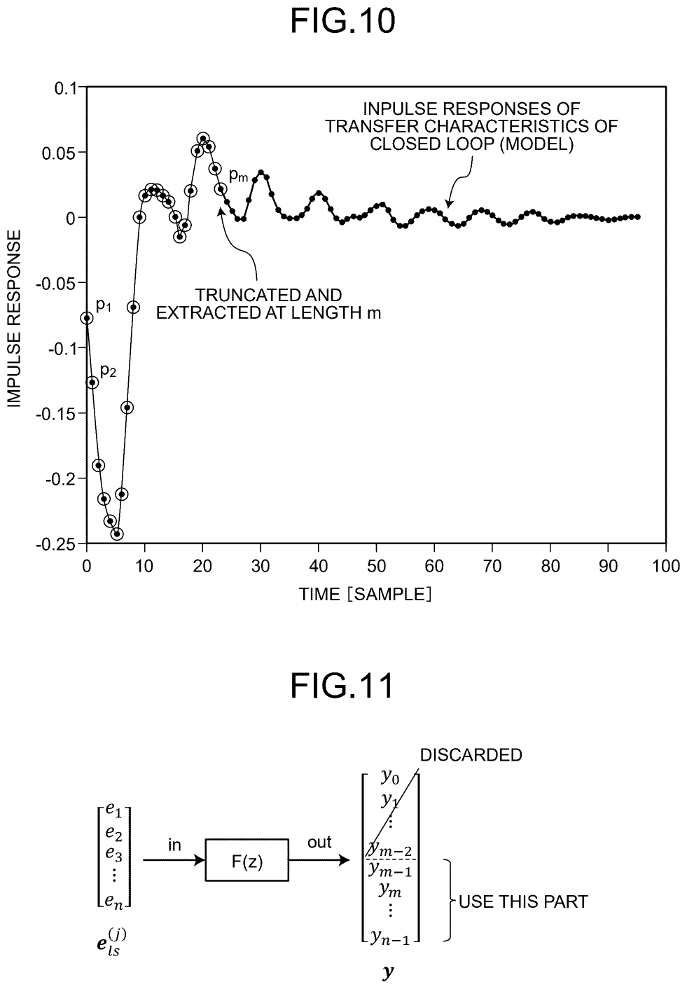

FIG. 10 illustrates an example of the impulse responses when the closed-loop transfer characteristic model is calculated based on the model of the VCM 15.

The learning control unit 40 truncates the acquired impulse responses at a length m that can roughly approximate a waveform of the impulse response, and extracts the truncated impulse responses (see FIG. 10). Then, in the learning control unit 40, an approximate matrix of Pₗₛ is configured as in the following expression (6) using the extracted sequence of impulse responses p₁, p₂, . . . , pₘ₋₁, pₘ. Consequently, the learning control unit 40 can perform control such that the evaluation section length N of the position errors is longer than the output section length M of the learning control inputs by performing the iterative learning according to expression (7).

$${\tilde{P}}_{ls} = [ \begin{matrix}{p}_{1} & & & & \\ {p}_{2} & {p}_{1} & & 0 & \\ ⋮ & {p}_{2} & ⋱ & & \\ {p}_{m - 1} & ⋮ & ⋱ & {p}_{1} & \\ {p}_{m} & {p}_{m - 1} & ⋱ & {p}_{2} & {p}_{1} \\ & {p}_{m} & ⋱ & ⋮ & {p}_{2} \\ & & ⋱ & {p}_{m - 1} & ⋮ \\ & 0 & & {p}_{m} & {p}_{m - 1} \\ & & & & {p}_{m}\end{matrix} ] \qquad expression ( 6 )$$

$${\tilde{P}}_{ls} \qquad expression ( 6 A )$$

Expression (6A) as the left-hand side in the expression (6) represents an approximation matrix of Pₗₛ in expression (5). In expression (6), p₁ to pₘ represent a sequence of m impulse responses.

The update expression for learning using the approximation matrix of Pₗₛ is expressed by expression (7) below.

$${u}_{ls}^{( j + 1 )} = {u}_{ls}^{( j )} + β {\tilde{P}}_{ls}^{T} {e}_{ls}^{( j )} \qquad expression ( 7 )$$

In expression (7), uₗₛ represents the vector of learning control inputs and eₗₛ represents the vector of position errors. In expression (7), j represents the number of learning iterations, and β represents the learning gain. Expression (6A) in the expression (7) represents expression (6).

$${\tilde{P}}_{ls}^{T} {e}_{ls}^{( j )} \qquad expression ( 7 A )$$

Here, expression (7A) in the expression (7) is an operation of a matrix×a vector. This operation may be difficult to be performed with the computing capability of the CPU 186 (see FIG. 1) of the actual HDD 10.

Therefore, in the learning control unit 40, it is preferable that a calculation of expression (7A) is replaced with a Finite Impulse Response (FIR) filter.

For this FIR filter, a filter expressed by the following expression (8) with the coefficients of the sequence of impulse responses p₁, p₂, . . . , pₘ₋₁, pₘ extracted in FIG. 10 being arranged in reverse time order may be used.

$$F ( z ) = {p}_{m} + {p}_{m - 1} {z}^{- 1} + ⋯ + {p}_{2} {z}^{m - 2} + {p}_{1} {z}^{m - 1} \qquad expression ( 8 )$$

In expression (8), F (z) represents the filter and z represents a delay operator. In expression (8), p₁ to pₘ represent a sequence of m impulse responses.

Let y be a vector output when the position error vector eₗₛ^{(j)} is input to the FIR filter expressed by expression (8), as illustrated in FIG. 11, the remainder obtained by removing m−1 delayed components of the FIR filter from y is equal to the vector obtained by the calculation of the above expression (7A) in the above expression (7). FIG. 11 is an explanatory diagram of the FIR filter.

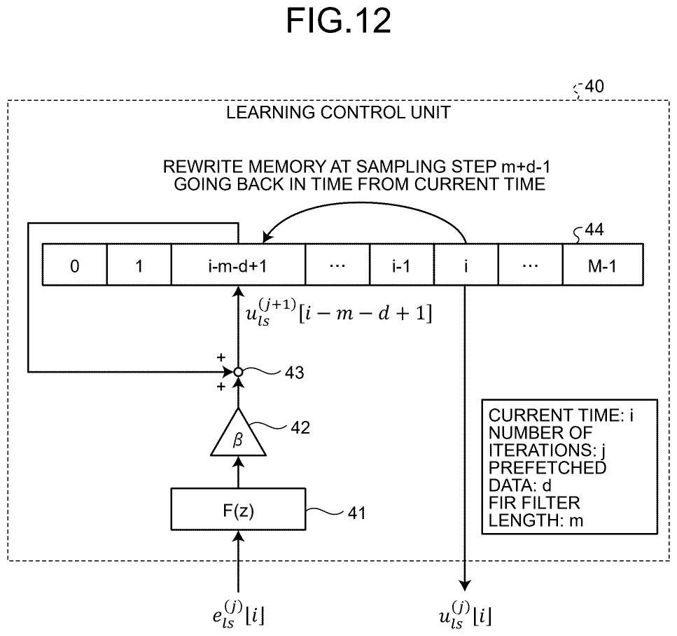

FIG. 12 is a schematic diagram of an example of a configuration of the learning control unit 40 according to the present embodiment, including the FIR filter.

The learning control unit 40 includes an FIR filter 41, a gain multiplier 42, an adder 43, and a memory 44.

A memory 44 is used to store the learning control input at each sampling step i. A memory length of the memory 44 may be the same length as the output section length M.

The FIR filter 41 outputs, to the gain multiplier 42, the position error signal after filtering the position error eₗₛ^{(j)}[i] input by the feedback path F at each sampling step i. The gain multiplier 42 multiplies the position error signal received from the FIR filter 41 by a gain β. The adder 43 updates the learning control input stored in a memory at a sampling step i−m−d+1 among memories included in the memory 44 to an addition result obtained by adding a multiplication result obtained by multiplying the position error signal by the gain β to the learning control input read from the memory 44. m represents a FIR filter length. m−d+1 corresponds to the phase delay amounts of both a phase delay of the control target 34, which exhibits the closed-loop transfer characteristic illustrated in FIG. 4, and a phase delay of the FIR filter 41.

Therefore, the learning control input stored in the memory 44 at the sampling step i−m−d+1 going back in time from the current time i is updated according to a newly observed position error.

Thus, in the present embodiment, in order to prevent the learning from becoming unstable due to both the phase delay of the control target 34, which exhibits the closed-loop transfer characteristic illustrated in FIG. 4, and the phase delay of the FIR filter 41, the learning control unit 40 updates the memory backward from the current time i by both the phase delay amounts. In other words, the time at which the learning control unit 40 reads a value stored in the memory 44 from the memory 44 as the learning control input to be output to the feedback path F is a time in the future relative to the time when the memory 44 is updated. Therefore, the learning control unit 40 can advance the phase by updating the memory backward from the current time i by both the above phase delay amounts, and can thereby correct the above phase delays.

As described above, the HDD 10 (learning control device, magnetic disk device) according to the present embodiment includes the feedback control unit 30 and the learning control unit 40.

The feedback control unit 30 outputs, based on an input signal according to a tracking error (position error) between an operation result state of the control target 34 operating according to an input control signal based on a feedback signal and a target state, the feedback signal to cause the operation result state (head position) of the control target 34 (magnetic head 12) to track the target state (target trajectory). The learning control unit 40 outputs to the feedback path F, through which the input signal according to the tracking error is sent to be input to the feedback control unit 30, the learning control input that has been updated according to the tracking error to cause the tracking error to approach zero asymptotically. The evaluation section length N of the evaluation section S1 of the tracking error by the learning control unit 40 is longer than the output section length M of the output section S2 in which the learning control unit 40 outputs the learning control inputs to the feedback path F (N>M).

Therefore, the learning control unit 40 according to the present embodiment can suppress the transient response occurring at the moment when the learning control is terminated, which occurs in the conventional technology, and can suppress the accuracy deterioration of the operation result state of the control target relative to the target state.

Consequently, the HDD 10 (learning control device, magnetic disk device) according to the present embodiment can improve the accuracy of the operation result state of the control target 34 relative to the target state.

When the HDD 10 according to the present embodiment is a magnetic disk device, the positioning accuracy of the head position of the magnetic head 12 can be improved.

### Effects

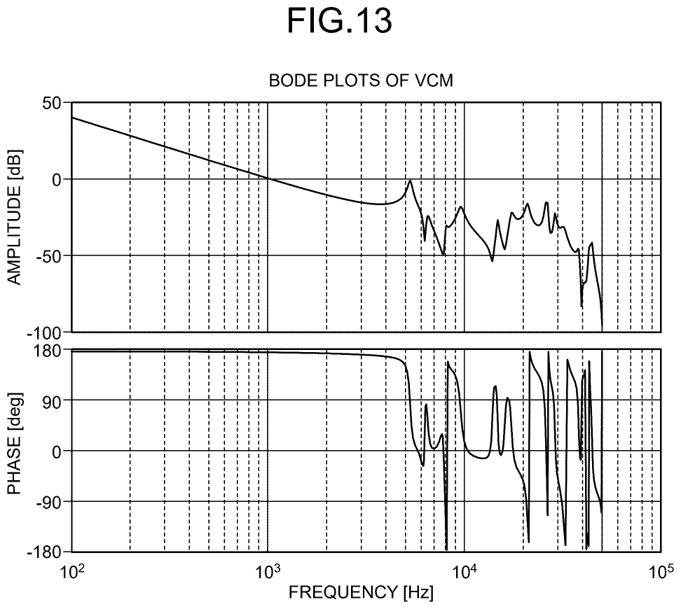

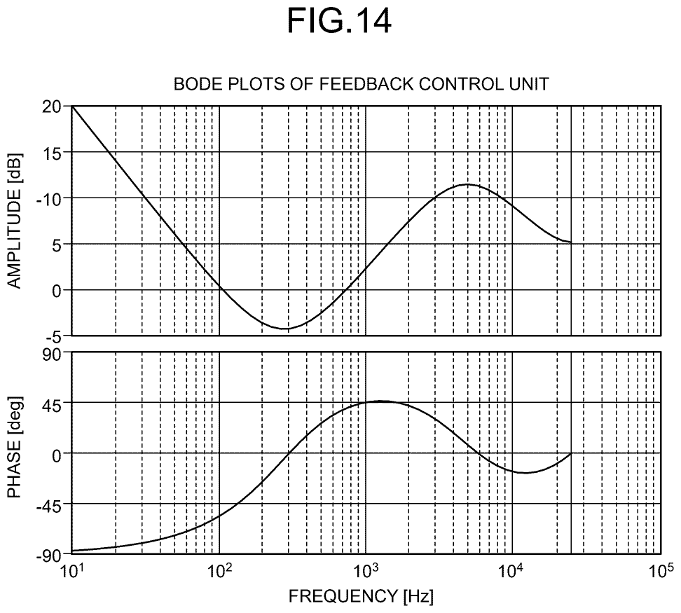

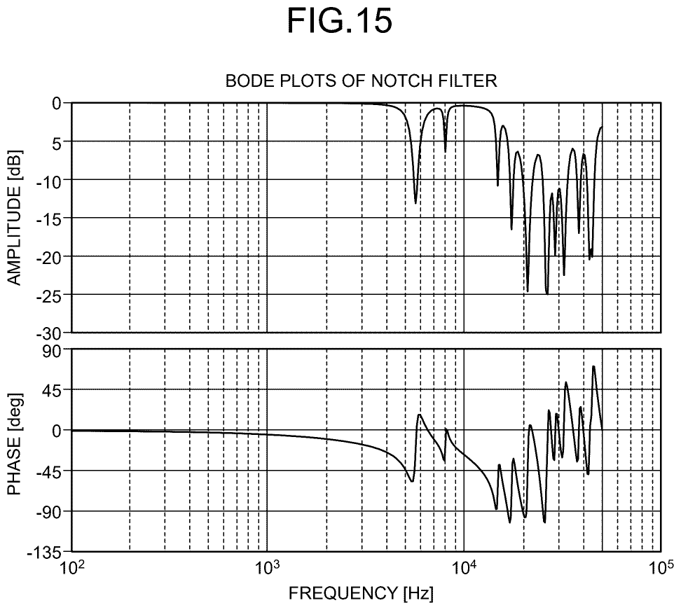

FIGS. 13 to 19 are explanatory diagrams of results of numerical simulations of the HDD 10 according to the present embodiment and the conventional technologies.

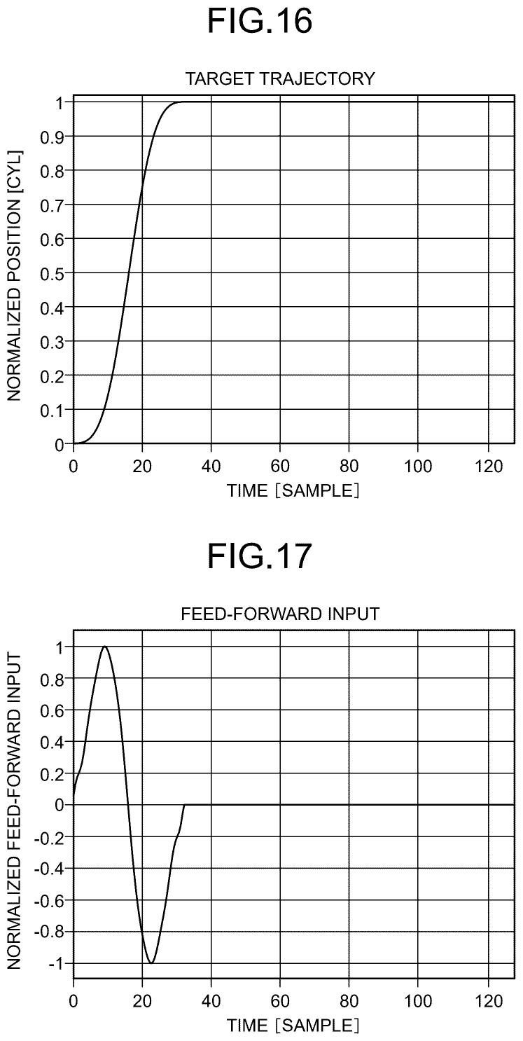

FIGS. 13, 14, and 15 illustrate Bode plots of a model of the VCM 15, the notch filter 31, and the feedback control unit 30 illustrated in FIG. 2, respectively. FIGS. 16 and 17 illustrate the time histories of the target trajectory and the FF input 32 in FIG. 2, respectively. The model of the VCM 15, the notch filter 31, and the feedback control unit 30 illustrated in the reference “http://www2.iee.or.jp/˜dmec/committee/DMEC1005/dsa_HDD_ben ch_e.html” (HDD benchmark problem) were used.

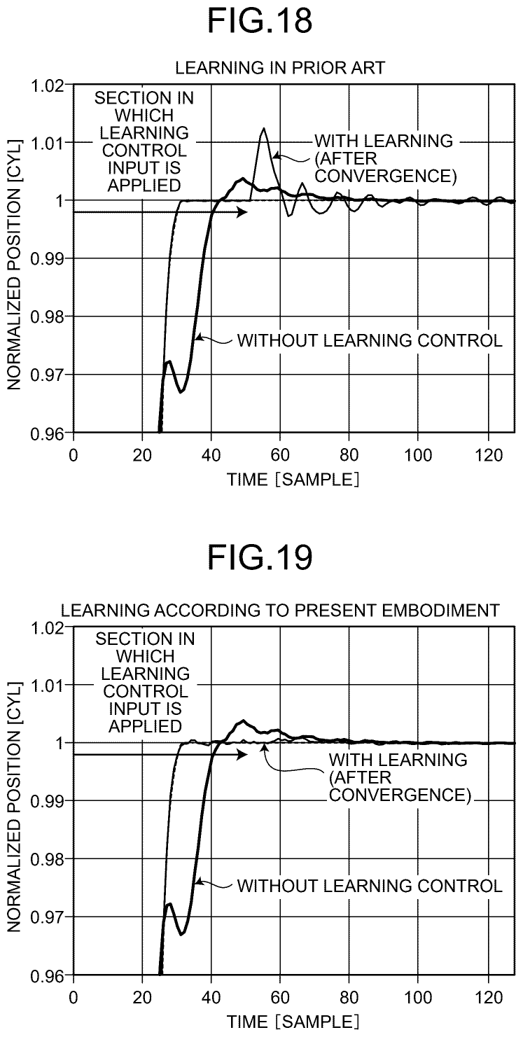

FIG. 18 is a diagram comparing the numerical simulation results of operations of the conventional learning control using the above components, and FIG. 19 is a diagram comparing the numerical simulation results of operations of the learning control according to the present embodiment using the above components. FIG. 18 illustrates the numerical simulation results of operations of the conventional learning control. FIG. 19 illustrates the numerical simulation results of operations of the learning control according to the present embodiment.

In both FIG. 18 and FIG. 19, the output section length M of the output section S2 of the learning control inputs is a length of 48 samples. The evaluation section length N of the evaluation section S1 of the position errors in the conventional learning control illustrated in FIG. 18 is a length of 48 samples. The evaluation section length N of the evaluation section S1 of the position errors in the learning control according to the present embodiment illustrated in FIG. 19 is a length of 78 samples. In other words, in the learning control according to the present embodiment illustrated in FIG. 19, in order to mitigate the transient response, the length of the position error signals included in the learning after the end of the learning control was set to 30 samples.

FIGS. 18 and 19 each illustrate curve diagrams representing both the head position trajectory in the seek control without the learning control and the head position trajectory after the learning has converged sufficiently. Due to the effect of the learning control, the head position tracks the target trajectory indicated by the dashed line in the figures well in the section where the learning control inputs are applied to the feedback path F in both learning. However, in the conventional learning control illustrated in FIG. 18, a transient response occurs at the moment when the application of the learning control input is terminated, and the head position is offset. On the other hand, it is found that this transient response is mitigated in the learning control according to the present embodiment illustrated in FIG. 19.

As described above, the present embodiment can suppress the transient response occurring at the moment when the learning control is terminated, which occurs in the conventional technology, and can suppress the accuracy deterioration of the operation result state of the control target relative to the target state. Consequently, the HDD 10 (learning control device, magnetic disk device) according to the present embodiment can improve the accuracy of the operation result state of the control target 34 relative to the target state. When the HDD 10 according to the present embodiment is a magnetic disk device, the positioning accuracy of the head position of the magnetic head 12 can be improved.

Each unit of the seek control section 19 illustrated in FIG. 2 is implemented by, for example, one or more processors. For example, each of the above units may be implemented by causing a processor such as the CPU 186 to execute a computer program, that is, by software. Each of the above units may be implemented by a processor such as a dedicated integrated circuit (IC), that is, by hardware. Each of the above units may be implemented using a combination of software and hardware. When a plurality of processors are used, each processor may implement one of the units or two or more of the units.

A computer program to be executed by the magnetic disk drive and the learning control device according to the embodiment is installed in a program ROM or the like in advance and provided.

The computer program to be executed by the magnetic disk device and the learning control device according to the embodiment may be an installable or executable format file and stored in a computer readable storage medium such as a compact disc read only memory (CD-ROM), a flexible disk (FD), a compact disc-recordable (CD-R), and a digital versatile disc (DVD), and may be provided as a computer program product.

Furthermore, the computer program to be executed by the magnetic disk device and the learning control device according the embodiment may be stored in a computer connected to a network such as the Internet, and may be provided by having the computer program downloaded via the network. The computer program to be executed by the magnetic disk drive and the learning control device according to the embodiment may be configured to be provided or distributed via a network such as the Internet.

The computer program to be executed by the magnetic disk device and the learning control device according to the embodiment can cause the computer to function as each unit of the magnetic disk device described above. In this computer, the CPU 186 can read a computer program from a computer readable storage medium onto a main memory to execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning control device comprising:
one or more hardware processors configured to function as:
a feedback control unit that outputs, based on an input signal according to a tracking error between an operation result state of a control target operating according to an input control signal based on a feedback signal and a target state, the feedback signal to cause the operation result state of the control target to track the target state; and
a learning control unit that outputs to a feedback path, through which the input signal according to the tracking error is sent to be input to the feedback control unit, a learning control input updated according to the tracking error to cause the tracking error to approach zero asymptotically, wherein
an evaluation section length of an evaluation section by the learning control unit for the tracking error is longer than an output section length of an output section in which the learning control unit outputs the learning control input to the feedback path.

2. The learning control device according to claim 1, wherein the learning control unit performs iterative learning for obtaining a least-squares solution of expression (4),
$${u}_{ls} = - {P}_{ls}^{†} {d}_{ls} \qquad expression ( 4 )$$
$$† \qquad expression ( 4 A )$$
where, in expression (4), uₗₛ represents a vector of learning control inputs, Pₗₛ represents a matrix in which sequences of impulse responses are arranged while being shifted by one sampling time, dₗₛ represents a vector of tracking errors when learning control is disabled, and expression (4A) in expression (4) represents a pseudo-inverse matrix operation.

3. The learning control device according to claim 2, wherein the learning control unit performs iterative learning according to expression (5),
$${u}_{ls}^{( j + 1 )} = {u}_{ls}^{( j )} + β {P}_{is}^{T} {e}_{ls}^{( j )} \qquad expression ( 5 )$$
where, in expression (5), uₗₛ represents a vector of learning control inputs, Pₗₛ represents a matrix in which sequences of impulse responses are arranged while being shifted by one sampling time, eₗₛ represents a vector of position errors, j represents a number of learning iterations, and β represents a learning gain.

4. The learning control device according to claim 3, wherein the learning control unit performs iterative learning according to expression (7),
$${\tilde{P}}_{ls} = [ \begin{matrix}{p}_{1} & & & & \\ {p}_{2} & {p}_{1} & & 0 & \\ ⋮ & {p}_{2} & ⋱ & & \\ {p}_{m - 1} & ⋮ & ⋱ & {p}_{1} & \\ {p}_{m} & {p}_{m - 1} & ⋱ & {p}_{2} & {p}_{1} \\ & {p}_{m} & ⋱ & ⋮ & {p}_{2} \\ & & ⋱ & {p}_{m - 1} & ⋮ \\ & 0 & & {p}_{m} & {p}_{m - 1} \\ & & & & {p}_{m}\end{matrix} ] \qquad expression ( 6 )$$
$${\tilde{P}}_{ls} \qquad expression ( 6 A )$$
$${u}_{ls}^{( j + 1 )} = {u}_{ls}^{( j )} + β {\tilde{P}}_{ls}^{T} {e}_{ls}^{( j )} \qquad expression ( 7 )$$
where, expression (6A) as a left-hand side in expression (6) represents an approximation matrix of Pₗₛ in expression (5); p₁ to pₘ in expression (6) represent a sequence of m impulse responses; in expression (7), uₗₛ represents a vector of learning control inputs, eₗₛ represents a vector of position errors, j represents a number of learning iterations, and β represents a learning gain; and expression (6A) in the expression (7) represents expression (6).

5. The learning control device according to claim 4, wherein the learning control unit inputs a plurality of the tracking errors sequentially sampled from the feedback path to a filter expressed by expression (8), and updates the learning control input using the tracking errors output from the filter,
$$F ( z ) = {p}_{m} + {p}_{m - 1} {z}^{- 1} + ⋯ + {p}_{2} {z}^{m - 2} + {p}_{1} {z}^{m - 1} \qquad expression ( 8 )$$
where, in expression (8), F (z) represents the filter, z represents a delay operator, and p₁ to pₘ represent a sequence of m impulse responses.

6. The learning control device according to claim 1, wherein the evaluation section and the output section partially overlap each other.

7. The learning control device according to claim 1, wherein
a start timing of the evaluation section is same as a start timing of the output section, and
an end timing of the evaluation section is later than an end timing of the output section.

8. The learning control device according to claim 1, wherein
the control target is a magnetic head,
the operation result state is for a head position of the magnetic head on the magnetic disk,
the target state is a target trajectory of the magnetic head, and
the tracking error is a position error.

9. A learning control method performed by a computer of a learning control device, the method comprising:
outputting, based on an input signal according to a tracking error between an operation result state of a control target operating according to an input control signal based on a feedback signal and a target state, the feedback signal to cause the operation result state of the control target to track the target state; and
performing a learning control by outputting, to a feedback path, through which the input signal according to the tracking error is sent to be input to an outputting operation, a learning control input updated according to the tracking error to cause the tracking error to approach zero asymptotically, wherein
an evaluation section length of an evaluation section by the learning control for the tracking error is longer than an output section length of an output section in which the learning control outputs the learning control input to the feedback path.

10. A magnetic disk device comprising:
a feedback control unit that outputs, based on an input signal according to a position error of a head position of a magnetic head configured to move the head position according to an input control signal based on a feedback signal, relative to a target trajectory on a magnetic disk, the feedback signal to cause the head position of the magnetic head to track the target trajectory; and
a learning control unit that outputs to a feedback path, through which the input signal according to the position error is sent to be input to the feedback control unit, a learning control input updated according to the position error to cause the position error to approach zero asymptotically, wherein
an evaluation section length of an evaluation section by the learning control unit for the position error is longer than an output section length of an output section in which the learning control unit outputs the learning control input to the feedback path.
